(19) United States
(12) Patent Application Publication
(10) Pub. No.: US 2006/0215228 A1
(43) Pub. Date: Sep. 28, 2006

(54) Image forming apparatus, image output apparatus, image forming method, image output method, programs for implementing the methods, and storage media storing the programs

(75) Inventor: Keishi Inaba, Yokohama-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/387,035

(22) Filed: Mar. 22, 2006

(30) Foreign Application Priority Data
Mar. 23, 2005 (JP) 2005-083491

(51) Int. Cl. H04N 1/40

(52) U.S. Cl. 358/3.28

(57) ABSTRACT

An image forming apparatus which can produce an original document for which security can be maintained. An image on a recording sheet based on inputted data is formed by the image forming apparatus. In a case that a storage medium is attached to the recording, the set output restriction information is written onto the storage medium sheet when the image formation is carried out.

### BACKGROUND OF THE INVENTION

1. Field of the Invention

The present invention relates to an image forming apparatus, an image output apparatus capable of reading an original to which a storage medium has been attached, an image forming method, an image output method, programs for implementing the methods, and storage media for storing the programs, and in particular to an image forming apparatus capable of forming an image on a recording sheet to which a storage medium such as a wireless tag has been attached, an image output apparatus capable of reading an original to which a storage medium has been attached, an image forming method, an image output method, programs for implementing the methods, and storage-media for storing the programs.

2. Description of the Related Art

In recent years, network environments containing many appliances such as personal computers (PCs), printers, digital copiers, and the like have been constructed in offices and the like to increase convenience and facilitate the sharing of information, for example.

On such a network environment, when the user prints document data from a PC, the user selects, via the PC, one out of the printers and digital copiers that have a printer function on the network as an output device to have the document data transmitted from the PC to the selected output device. By doing so, the document data is printed at the selected output device and a printed document is obtained.

When printing is carried out for document data that is highly secret, for example, the printed document is normally kept and managed by the user as an original document that is highly secret and is disposed of after use by shredding using a shredder or the like. Here, when an original document that is highly secret is kept and managed by the user, the decision as to whether copying of the original document is permitted is normally made by the user who manages the original document, and therefore security measures with regard to flow of information due to the original document being copied or the like are left up to the user.

Recently, contactless IC chips that are extremely small and are capable of writing and reading information have been introduced. The contactless IC chips are already being attached to products or the like and used as wireless tags for managing the products. Also, a method for managing security by providing a wireless tag on a recording medium to prevent the recording medium from being unnecessarily carried out of a managed area, such as outside an enterprise, and to also prevent information from disseminating from a recording medium that has been carried out has been proposed (see, for example Japanese Laid-Open Patent Publication (Kokai) No. 2003-317048).

However, when an original document that is highly secret is kept and managed by the user, although it is possible to restrict the carrying of the original document outside an enterprise or the like by attaching a wireless tag to the original document, it is not possible to prevent the user who manages the original document from making a copy of the original document without permission within the enterprise, for example, and carrying the copy outside the enterprise. Therefore, improved security is desired for original documents.

### SUMMARY OF THE INVENTION

It is a first object of the present invention to provide an image forming apparatus, an image forming method, a program for implementing the method, and a storage medium storing the program which can produce an original document for which security can be maintained.

It is a second object of the present invention to provide an image output apparatus, an image output method, a program for implementing the method, and a storage medium storing the program that can prevent inappropriate flow of information from an original document.

To attain the above object, in a first aspect of the present invention, there is provided an image forming apparatus that forms an image on a recording sheet based on inputted data, comprising an output restriction information setting unit that sets output restriction information, and an information writing unit that starts, in a case that a storage medium is attached to the recording sheet, writing the set output restriction information onto the storage medium, when the image formation is carried out.

Preferably, the output restriction information includes apparatus identifying information of an apparatus permitted copy output from an image formed on. the recording sheet after the image formation is carried out.

Preferably, the output restriction information includes apparatus identifying information of an apparatus permitted transmission to an image formed on the recording sheet after the image formation is carried out and recipient information of the apparatus permitted as recipients of the image.

Preferably, the image forming apparatus further comprises a connecting unit that connects to a network, wherein the output restriction information setting unit obtains the output restriction information to be set from an appliance on the network.

Preferably, the image forming apparatus further comprises an output restriction information input unit that inputs the output restriction information, wherein the output restriction information setting unit obtains the output restriction information inputted by the output restriction information input unit.

Preferably, the image forming apparatus further comprises a canceling unit that determines whether a storage medium is writable for the output restriction information set by the output restriction information setting unit is attached to the recording sheet and cancels the image formation when the storage medium is not attached.

To attain the above object, in a second aspect of the present invention, there is provided an image output apparatus comprising an original reading unit that reads an image on an original, an output unit that outputs information based on the read image, an information reading unit that reads output restriction information from a storage medium attached to the original, and an output control unit that controls output by the output unit based on the output restriction information read by the information reading unit.

Preferably, the output restriction information includes apparatus identifying information of an apparatus permitted copy output of an image read from the storage medium-attached original, the output unit is composed of a print unit that prints information based on the image read from the storage medium-attached original, and the output control unit that permits, in a case that the apparatus identifying information of the output restriction information matches apparatus identifying information of the image output apparatus, the output unit to print information based on the image read from the storage medium-attached original.

Preferably, the output restriction information includes apparatus identifying information of an apparatus permitted transmission of information based on an image read from the storage medium-attached original and recipient information of the apparatus permitted as recipients of the image, the output unit is composed of a transmission unit that transmits information based on the image read from the storage medium-attached original to a designated recipient, and the output control unit that permits, in a case that the apparatus identifying information of the output restriction information matches apparatus identifying information of the image output apparatus and the recipient information of the output restriction information matches the designated recipient, the output unit to transmit information based on the image read from the storage medium-attached original.

Preferably, the output control unit that inhibits output by the output unit, in a case a wireless tag is not attached to the original read by the original reading unit.

To attain the above object, in a third aspect of the present invention, there is provided an image forming method of forming an image on a recording sheet based on inputted data, comprising an output restriction information setting step of setting output restriction information, and an information writing step of starting, in a case that a storage medium is attached to the recording sheet, writing the set output restriction information onto the storage medium, when the image formation is carried out.

To attain the above object, in a fourth aspect of the present invention, there is provided an image forming method of an image output apparatus comprising an original reading unit that reads an image on an original and an output unit that outputs information based on the read image, the image forming method comprising an information reading step of reading output restriction information from a storage medium attached to the original, and an output control step of controlling output by the output unit based on the output restriction information read in the information reading step.

To attain the above object, in a fifth aspect of the present invention, there is provided a program for causing a computer to control an image forming apparatus that forms an image on a recording sheet based on inputted data, the program comprising an output restriction information setting module for setting output restriction information, and an information writing module for starting, in a case that a storage medium is attached to the recording sheet, writing the set output restriction information onto a storage medium when the image formation is carried out.

Preferably, a computer-readable recording medium stores the above program.

To attain the above object, in a sixth aspect of the present invention, there is provided a program for causing a computer to control an image output apparatus comprising an original reading unit that reads an image on an original, and an output unit that outputs information based on the read image, the program comprising an information reading module for reading output restriction information from a storage medium attached to the original, and an output control module for controlling output by the output unit based on the output restriction information read by the information reading module.

Preferably, a computer-readable recording medium storing the above program.

The above and other objects, features, and advantages of the invention will become more apparent from the following detailed description taken in conjunction with the accompanying drawings.

### BRIEF DESCRIPTION OF THE DRAWINGS

FIG. 1 is a diagram schematically showing the construction of a network to which image forming apparatuses according to an embodiment of the present invention are connected;

FIG. 2 is a block diagram showing the internal construction of the image forming apparatuses appearing in FIG. 1;

FIG. 3 is a view showing the appearance of the image forming apparatus;

FIG. 4 is a flowchart showing the procedure of a print output process for producing an original document using the image forming apparatuses;

FIG. 5 is a flowchart showing the procedure of a copy process for a wireless tag-attached original document capable of restricting copying using an image forming apparatus; and

FIG. 6 is plan view showing a wireless tag-attached original document produced by the procedure shown by the flowchart in FIG. 4.

### DETAILED DESCRIPTION OF THE PREFERRED EMBODIMENTS

The present invention will now be described in detail with reference to the drawings showing preferred embodiments thereof. It should be noted that the relative arrangement of the components, the numerical expressions and numerical values set forth in these embodiments do not limit the scope of the present invention unless it is specifically stated otherwise.

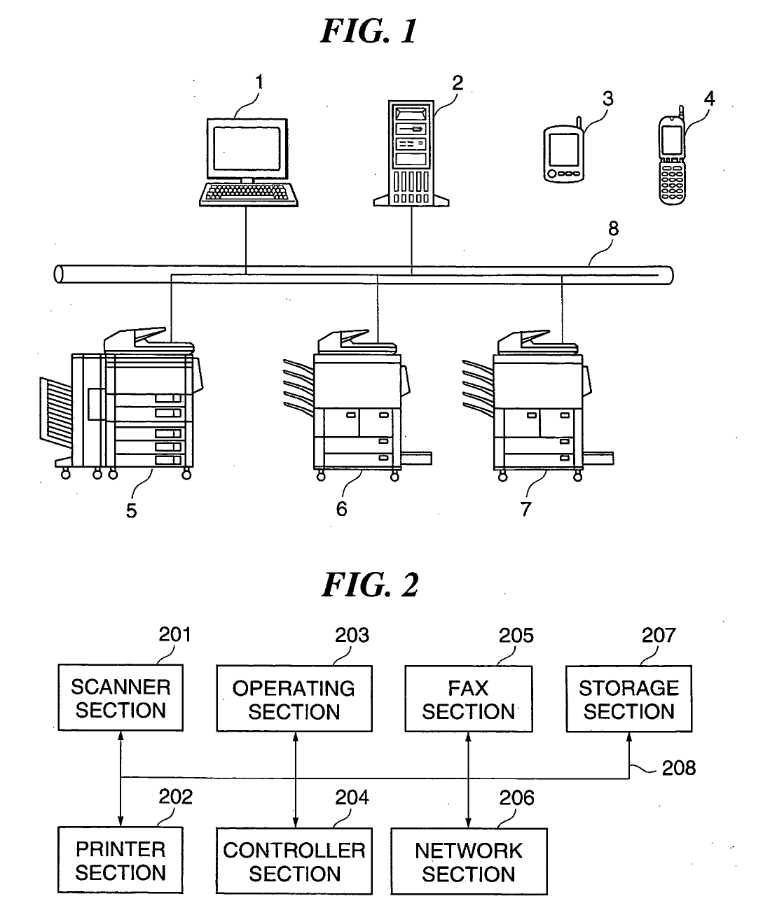

FIG. 1 is a diagram schematically showing the construction of a network to which image forming apparatuses according to an embodiment of the present invention are connected.

In FIG. 1, a plurality of image forming apparatuses 5, 6, and 7 are connected to a network 8. A computer 1 and a server 2 are also connected to the network 8. In addition, the network 8 corresponds to a wireless LAN (Local Area Network) and can connect to appliances with a wireless communication function, such as a PDA (Personal Digital Assistant) terminal 3 and a mobile phone 4.

The computer 1 functions as a client of the server 2, and transmits and receives data to and from the network 8. The server 2 has a plurality of server functions such as a file server that constructs a database and files and provides files that can be shared by a plurality of users, a print server that manages printers on the network 8, and a mail server that transmits and receives electronic mail. The PDA terminal 3 is internally equipped with a wireless LAN function for connecting to the network 8, functions as a client of the server 2, and transmits and receives data to and from the network 8. The mobile telephone 4, like the PDA terminal 3, can connect to the network 8 via a telephone network and functions as a client of a server 2, and transmits and receives data to and from the network 8.

The respective image forming apparatuses 5, 6, and 7 are digital multifunction devices that have a plurality of functions such as a copy function, a scanner function, a facsimile function, a printer function, and a data transfer function. The image forming apparatuses 5, 6, and 7 are described in detail later.

Although the computer 1, the server 2, the PDA terminal 3, the mobile telephone 4 are given here as appliances that are connected to or can connect to the network 8, the present invention is not limited to such appliances and the number of appliances of the same type is not limited to one.

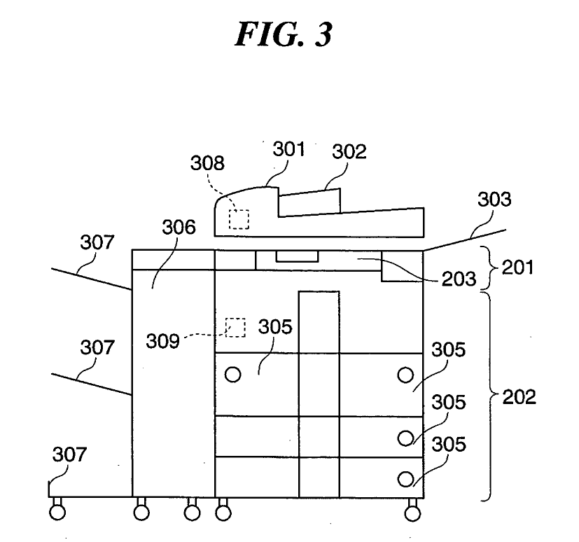

Next, the image forming apparatuses 5, 6, and 7 will be described in detail with reference to FIGS. 2 and 3. FIG. 2 is a block diagram showing the internal construction of the image forming apparatuses 5, 6, and 7 appearing in FIG. 1 and FIG. 3 is a view showing the appearance of the image forming apparatus 5.

As shown in FIG. 2, the image forming apparatuses 5, 6, and 7 respectively include a scanner section 201, a printer section 202, an operating section 203, a controller section 204, a facsimile (hereinafter “fax”) section 205, a network section 206, and a storage section 207, with the respective sections being connected so as to be capable of communicating with one another via an internal bus 208.

The scanner section 201 reads an original and outputs image data of the original either via the internal bus 208 to the controller section 204 and the network section 206, or to the storage section 207. The printer section 202 forms an image on a sheet based on data inputted via the internal bus 208 from the controller section 204. The operating section 203 includes a liquid crystal display panel for displaying an apparatus state and the like and a plurality of hard keys for inputting various settings, values, and the like. The fax section 205 is connected to a public telephone line and carries out fax transmission and reception via the public telephone line. The network section 206 is connected to the network 8 and carries out communication control to communicate with the appliances on the network 8. The storage section 207 stores image data read by the scanner section 201, data transmitted and received via the network section 206, and the like.

Here, as shown in FIG. 3, an original feeding device 301 for feeding originals one at a time from an original tray 302 onto an original platen (not shown) is mounted on the image forming apparatus 5. An original fed onto the original platen by the original feeding device 301 is read by the scanner section 201 and then discharged onto a discharge tray 303.

The original feeding device 301 is equipped with a wireless tag reader 308 for reading a wireless tag. The wireless tag reader 308 carries out a read operation on the original fed onto the original platen to read information from a wireless tag via wireless communication. From the result of the read operation by the wireless tag reader 308, it can be determined whether the fed document is a wireless tag-attached document. When the fed document is a wireless tag-attached document, the wireless tag reader 308 reads information written on the wireless tag (an ID for identifying the wireless tag, paper quality of the original, size-of the original, output restriction information, and the like). The read information is stored via the controller section 204 in the storage section 207.

Here, a wireless tag-attached document is formed an image on a sheet onto which a wireless tag is stuck or into which a wireless tag is embedded. The wireless tag is composed of a contactless IC chip capable of short-range wireless communication, and the contactless IC chip is equipped with a memory into and from which information can be written and/or read out, and a driving section that generates power from received radio waves and carries out a communication operation such as transmission and reception of information written into or read out from the memory using the generated power. This contactless IC chip is well known, and therefore description thereof is omitted.

The operating section 203 of the image forming apparatus 5 is provided on an upper surface of the apparatus main body.

A plurality of sheet feeding cassettes 305 are mounted on the printer section 202 of the image forming apparatus 5. The respective sheet feeding cassettes 305 store sheets of respectively corresponding sizes and feed the sheets one at a time into the apparatus main body. Toner images are transferred onto the respective sheets and fixed. By doing so, corresponding images are formed on the sheets. The sheets on which the images have been formed are sent to a finisher 306. The finisher 306 carries out post-processing (a stapling process, a folding process, and the like) on the sheets and the sheets are discharged to a stacking tray 307 corresponding to the sheets.

Also, a wireless tag reader/writer 309 is provided in the printer section 202 of the image forming apparatus 5, with the wireless tag reader/writer 309 being disposed at or near a sheet output of the printer section 202. The wireless tag reader/writer 309 carries out a read operation for information on a sheet discharged from the printer section 202 to the finisher 306 and determines whether the sheet is a wireless tag-attached sheet. Here, when the sheet is a wireless tag-attached sheet, information (an ID of the wireless tag, paper quality of the sheet, and sheet size) is read out from the wireless tag and at the same time, the ID of the image forming apparatus 5, information showing the processing content of the finisher 306, output restriction information, and the like are written. The information read from the wireless tag is stored via the controller section 204 in the storage section 207.

Although the image forming apparatuses 6 and 7 have a different external construction to the image forming apparatus 5, the fundamental constructions thereof are the same as the image forming apparatus 5. In the same way, the image forming apparatuses 6 and 7 include an original feeding device equipped with a wireless tag reader, not shown, and a printer section equipped with a wireless tag reader/writer.

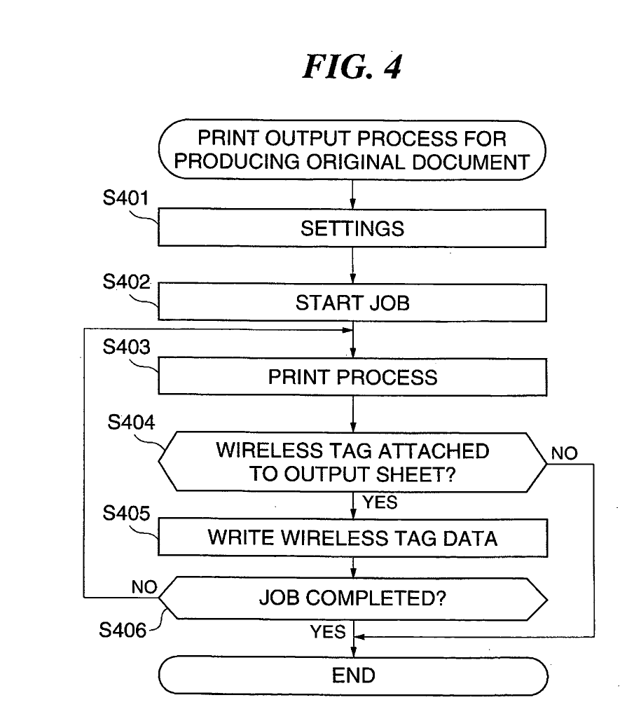

Next, a print output process for producing an original document using the image forming apparatuses 5, 6, and 7 will be described with reference to FIG. 4. FIG. 4 is a flowchart showing the procedure of the print output process for producing an original document using the image forming apparatuses 5, 6, and 7.

Here, the print output process for producing an original document includes formation of an image on a wireless tag-attached sheet and writing of at least output restriction information on the wireless tag of the sheet using an image forming apparatus selected out of the image forming apparatuses 5, 6, and 7. The output restriction information is information for restricting copy output of the produced original document, with such information including apparatus identifying information of an apparatus for which copy output is permitted.

More specifically, as shown in FIG. 4, first, in the computer 1, file data to be subjected to a print request is displayed and settings for printing the file data are made (step S401). These settings are made on a print setting screen displayed by a printer driver, and may include settings such as a selection of a printer (or apparatus with a printer function) on the network 8 to print the file data, a number of output sheets, a setting of magnification, and a setting of output restriction information for restricting copying of the produced original document. A setting of whether to notify the user of output completion is also made. As described later, these settings are transmitted from the computer 1 to the selected printer.

The output restriction information can be set by selecting an item in the settings described above. If a setting item for the output restriction information is selected, a list of apparatuses having a copy function on the network 8 is displayed and the apparatuses which user permits to copy the original document are selected from the list. The output restriction information including apparatus identification information (apparatus IDs) for identifying the selected apparatuses is then registered. In a default state, all of the apparatuses displayed in the list mentioned above are selected as apparatuses permitted to copy the original document. The image forming apparatuses 5, 6, and 7 are also capable of individually setting the output restriction information. In such case, by using the same procedure as that used by the computer 1 described above, the operating section 203 sets the output restriction information.

When such settings have been made, the computer 1 instructs the selected printer to start a print job (step S402). In accordance with the instruction for the start of the print job, a print job including the file data to be printed and the settings is transmitted from the computer 1 via the server 2 to the selected printer. In the following example, the case where the selected printer is the printer section 202 of the image forming apparatus 5 is described.

When the image forming apparatus 5 receives the print job, a print process is started (step S403). Here, the received print job is temporarily stored in the storage section 207 controlled by the controller section 204. After this, the controller section 204 reads out the file data from the storage section 207 into an internal memory of the controller section 204. The controller section 204 analyzes a type of process for the file data that has been read out and based on a result of such analysis, expands the file data to data that can be processed by the printer section 202. The expanded data is transferred from the controller section 204 to the storage section 207 and stored. Next, the controller section 204 reads out the expanded data in a page order thereof and transfers the expanded data to the printer section 202. The printer section 202 forms an image based on the transferred data onto a sheet fed from a corresponding sheet feeding cassette 305. Next, the sheet on which the image has been formed is sent to the finisher 306.

When the sheet on which the image has been formed is sent to the finisher 306, the wireless tag reader/writer 309 carries out a read operation on the sheet. When the read operation detects that the sheet on which the image has been formed is a wireless tag-attached sheet (“YES” to step S404), the read information described above (the ID of the wireless tag, the paper quality of the sheet, and the sheet size) is stored via the controller section 204 in the storage section 207. After the wireless tag reader/writer 309 has read the information from the wireless tag of the sheet, the settings made in the step S401 (the apparatus ID of the image forming apparatus carrying out this process, information showing a processing content of the finisher 306, and the output restriction information) are written onto the wireless tag of the sheet (step S405). Next, the controller section 204 determines whether the print job has been completed (step S406) and if the print job has not been completed, the processing returns to the step S403 and the print process continues. On the other hand, if the print job has been completed in the step S406, the present process is terminated.

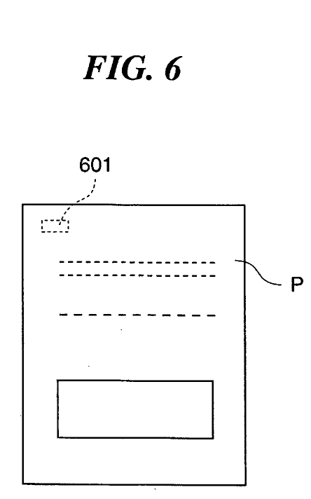

In this way, by writing the output restriction information onto the wireless tag of the sheet on which the image has been formed, it is possible to produce a wireless tag-attached original document capable of restricting copying. For example, a wireless tag 601-attached original document P as shown in FIG. 6 is obtained.

If it has been detected that the sheet on which the image has been formed is not a wireless tag-attached sheet (“NO” to the step S404), although not shown, the controller section 204 transmits an error message or the like showing that a wireless tag-attached sheet has not been fed to the computer 1 and the present process is terminated.

Note that although the case in the present invention where it is determined whether the sheet is a wireless tag-attached sheet and the output restriction information is written after the print process has been carried out in the step S403, security can be further improved by determining whether the sheet is a wireless tag-attached sheet before printing, and the result of which is that the sheet is a wireless tag-attached sheet, then the print process is carried out and restriction information onto the wireless tag is written out, on the other hand, the above result of which is that the sheet is not a wireless tag-attached sheet, then the print process is canceled and restriction information onto the wireless tag is also canceled.

Also, a construction may be used for the process shown in FIG. 4 where the user can select either the mode that improves the security as described above or a normal mode. In that case, a wireless tag-attached sheet is automatically selected in the mode that improves the security and a sheet without a wireless tag is automatically selected in the normal mode.

Also, in the process described above, the image formed on the sheet may be a predetermined pattern that cannot be read by the human eye, such image may be read by the scanner section 201 and decrypted based on predetermined key information to convert the pattern to a normal visible pattern. In this case, if a key used for the decryption is stored in the wireless tag, only apparatuses that can read the decryption key will be able to make the pattern visible, thereby improving security.

Alternatively, by using simple information as the image formed on the sheet and writing detailed information in the wireless tag, only specified apparatuses will be able to confirm the detailed information based on the output restriction information stored together with the detailed information.

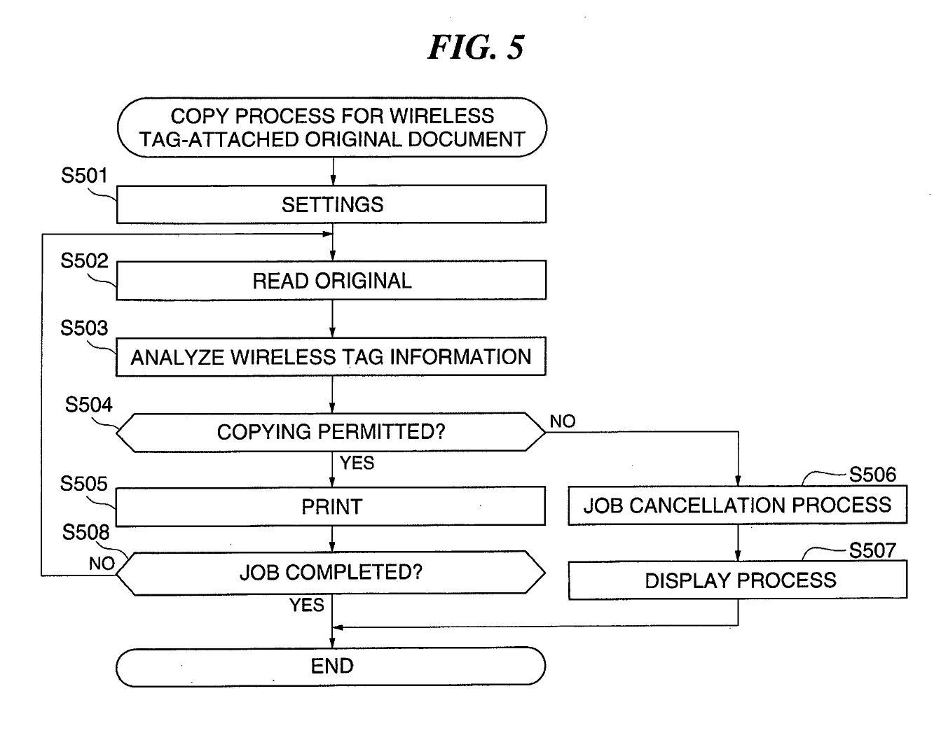

Next, the case where a wireless tag-attached original document, which is capable of restricting copying, is copied using the image forming apparatus 5 will be described with reference to FIG. 5. FIG. 5 is a flowchart showing the procedure of a copy process for a wireless tag-attached original document, which is capable of restricting copying using the image forming apparatus 5.

In FIG. 5, the wireless tag-attached original document is set on the original tray 302 of the image forming apparatus 5 and settings such as the number of copies are made on the operating section 203 (step S501). Next, when a start key of the operating section 203 is pressed, the wireless tag-attached original document is fed inside the image forming apparatus 5 and the wireless tag-attached original document is read by the scanner section 201 (step S502). Also, when the wireless tag-attached original document is fed, the wireless tag reader 308 reads the information of the wireless tag of the original document. Here, the image data read by the scanner section 201 and the information (the ID of the wireless tag, the paper quality of the sheet, the sheet size, the apparatus ID of the image forming apparatus that produced the original document, information showing the processing content of a finisher, and output restriction information) read from the wireless tag are temporarily stored via the controller section 204 in the storage section 207.

Next, the controller section 204 reads the information read from the wireless tag from the storage section 207 and analyzes the read information (step S503). Here, for example, the paper quality and the sheet size read from the wireless tag are compared to the paper quality and the sheet size to be fed inside the image forming apparatus 5 and based on the comparison result, it is determined whether a proper copying operation is possible. When a proper copying operation is not possible, a message indicated that is displayed on the operating section 203. The analysis described above also extracts the apparatus IDs from the output restriction information read from the wireless tag of the original document.

Next, the controller section 204 determines whether any of the apparatus IDs of the output restriction information read from the wireless tag of the original document matches an apparatus ID of the image forming apparatus 5 (step S504). If one of the apparatus IDs of the output restriction information matches the apparatus ID of the image forming apparatus 5, the controller section 204 determines that copying of the original document by the image forming apparatus 5 is permitted, reads out the image data of the original document from the storage section 207, transfers the image data to the printer section 202, and carries out a print process (step S505). Next, the controller section 204 determines whether the copy job has been completed (step S508) and when the copy job has not been completed, the processing returns to the step S502. When the copy job has been completed in the step S508, the present process is terminated.

On the other hand, if the controller section 204 determines in the step S504 that none the apparatus IDs of the output restriction information matches the apparatus ID of the image forming apparatus and copying of the original document by the image forming apparatus 5 is not permitted, the controller section 204 cancels the copy job and the image data of the original document and the information read from the wireless tag stored in the storage section 207 are deleted (step S506). Next, a message showing that copying is inhibited for the original document is displayed on the operating section 203 (step S507), and the present process is terminated.

Also, although a premise where a wireless tag-attached original document is read is described above, it is possible to further improve security by using a specification where copying is always inhibited when an original with no attached wireless tag is read.

Also, “copying” referred to here is not only reading an image on an original and forming the image on a sheet to reproduce the image, but also includes a process where a pattern that cannot be read by the human eye is formed in advance on an original as described above, with the pattern being decrypted according to key information written on the wireless tag and an image corresponding to the pattern being formed as visible information on a sheet.

According to the present embodiment, by writing output restriction information onto a wireless tag of a sheet on which an image has been formed, it is possible to produce an original document capable of restricting copy output and to prevent from improperly flowing information out of the wireless tag-attached original document. That is, in the network 8 environment, it is possible to prevent the original document from being copied without permission and to prevent from improperly flowing the copied document to the outside, and therefore it is possible to improve security for the original document.

Also, although the case where an original document capable of restricting copy output is produced has been described in the present embodiment, it is possible to produce an original document capable of restricting transmission, for example.

When a wireless tag-attached original document capable of restricting transmission is produced, output restriction information including the apparatus IDs of apparatuses permitted to transmit an image read from the wireless tag-attached original document and recipient information for the apparatus permitted certain recipients of the image is set (the step S401 in FIG. 4), and the output restriction information is written onto the wireless tag of the sheet on which the image has been formed (the step S405 in FIG. 4). Here, “transmission” includes a case where an image read from an original document is transmitted by fax and a case where the image is transmitted to another appliance via the network 8.

Here, for example, when a wireless tag-attached original document, for which fax transmission is restricted, is to be transmitted by fax using a fax function (the fax section 205) of the image forming apparatus 5, fax transmission and a recipient are set (the step S501 in FIG. 5). The output restriction information read from the wireless tag of the original document is analyzed and the apparatus IDs of apparatuses permitted to carry out fax transmission of the original document and the recipient information of these apparatuses are extracted from the output restriction information (the step S503 in FIG. 5). When one of the apparatus IDs of the output restriction information matches the apparatus ID of the image forming apparatus 5 and one recipient in the output restriction information matches the set recipient, fax transmission of an image read from the wireless tag-attached original is permitted (“YES” to the step S504 in FIG. 5). On the other hand, when none of the apparatus IDs of the output restriction information matches the apparatus ID of the image forming apparatus 5 and/or none of the recipient information in the output restriction information matches the set recipient, fax transmission of the image read from the wireless tag-attached original is not permitted (“NO” to the step S504 in FIG. 5).

Also, when an image read from the original document is to be transferred to another appliance via the network 8 using a data transfer function (the network section 206) of the image forming apparatus 5, output of the image read from the original document is restricted in the same way as fax transmission.

In such case also, it is possible to further improve security by always inhibiting transmission when an original with no attached wireless tag is read.

Also, instead of transmitting image data obtained by simply reading an image of an original, it is possible to form a pattern that cannot be read by the human eye on the original in advance and transmit an image obtained by decrypting the pattern according to key information written on the wireless tag.

It is to be understood that the object of the present invention may also be accomplished by supplying a system or an apparatus with a storage medium (or a recording medium) in which a program code of software, which realizes the functions of the above described embodiment is stored, and causing a computer (or CPU or MPU) of the system or apparatus to read out and execute the program code stored in the storage medium. In this case, the program code itself read out from the storage medium realizes the functions of the above described embodiment, and hence the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, a DVD-ROM, a DVD-RAM, a DVD−RW, a DVD+RW, a magnetic tape, a nonvolatile memory card, and a ROM. Alternatively, the program code may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

This application claims the benefit of Japanese Application No. 2005-083491, filed Mar. 23, 2005, which is hereby incorporated by reference herein in its entirety.

What is claimed is:

1. An image forming apparatus that forms an image on a recording sheet based on inputted data, comprising:
an output restriction information setting unit that sets output restriction information; and
an information writing unit that starts, in a case that a storage medium is attached to the recording sheet, writing the set output restriction information onto the storage medium, when the image formation is carried out.

2. An image forming apparatus according to claim 1,
wherein the output restriction information includes apparatus identifying information of an apparatus permitted copy output from an image formed on the recording sheet after the image formation is carried out.

3. An image forming apparatus according to claim 1,
wherein the output restriction information includes apparatus identifying information of an apparatus permitted transmission to an image formed on the recording sheet after the image formation is carried out and recipient information of the apparatus permitted as recipients of the image.

4. An image forming apparatus according to claim 1, further comprising a connecting unit that connects to a network, wherein said output restriction information setting unit obtains the output restriction information to be set from an appliance on the network.

5. An image forming apparatus according to claim 1, further comprising an output restriction information input unit that inputs the output restriction information,
wherein said output restriction information setting unit obtains the output restriction information inputted by said output restriction information input unit.

6. An image forming apparatus according to claim 1, further comprising a canceling unit that determines whether a storage medium is writable for the output restriction information set by said output restriction information setting unit is attached to the recording sheet and cancels the image formation when the storage medium is not attached.

7. An image output apparatus comprising:
an original reading unit that reads an image on an original;
an output unit that outputs information based on the read image;
an information reading unit that reads output restriction information from a storage medium attached to the original; and
an output control unit that controls output by said output unit based on the output restriction information read by said information reading unit.

8. An image output apparatus according to claim 7,
wherein the output restriction information includes apparatus identifying information of an apparatus permitted copy output of an image read from the storage medium-attached original, said output unit is composed of a print unit that prints information based on the image read from the storage medium-attached original, and said output control unit that permits, in a case that the apparatus identifying information of the output restriction information matches apparatus identifying information of the image output apparatus, said output unit to print information based on the image read from the storage medium-attached original.

9. An image output apparatus according to claim 7,
wherein the output restriction information includes apparatus identifying information of an apparatus permitted transmission of information based on an image read from the storage medium-attached original and recipient information of the apparatus permitted as recipients of the image,
said output unit is composed of a transmission unit that transmits information based on the image read from the storage medium-attached original to a designated recipient, and
said output control unit that permits, in a case the apparatus identifying information of the output restriction information matches apparatus identifying information of the image output apparatus and the recipient information of the output restriction information matches the designated recipient, said output unit to transmit information based on the image read from the storage medium-attached original.

10. An image output apparatus according to claim 7, wherein said output control unit that inhibits output by said output unit, in a case a wireless tag is not attached to the original read by said original reading unit.

11. An image forming method of forming an image on a recording sheet based on inputted data, comprising:
an output restriction information setting step of setting output restriction information; and
an information writing step of starting, in a case that a storage medium is attached to the recording sheet, writing the set output restriction information onto the storage medium, when the image formation is carried out.

12. An image forming method of an image output apparatus comprising an original reading unit that reads an image on an original and an output unit that outputs information based on the read image, the image forming method comprising:
an information reading step of reading output restriction information from a storage medium attached to the original; and
an output control step of controlling output by the output unit based on the output restriction information read in said information reading step.

13. A program for causing a computer to control an image forming apparatus that forms an image on a recording sheet based on inputted data, the program comprising:
an output restriction information setting module for setting output restriction information; and
an information writing module for starting, in a case that a storage medium is attached to the recording sheet, writing the set output restriction information onto a storage medium when the image formation is carried out.

14. A computer-readable recording medium storing a program according to claim 13.

15. A program for causing a computer to control an image output apparatus comprising an original reading unit that reads an image on an original, and an output unit that outputs information based on the read image, the program comprising:
an information reading module for reading output restriction information from a storage medium attached to the original; and
an output control module for controlling output by the output unit based on the output restriction information read by said information reading module.

16. A computer-readable recording medium storing a program according to claim 15.
